(19) United States
(12) Patent Application Publication
(10) Pub. No.: US 2023/0341545 A1
(43) Pub. Date: Oct. 26, 2023

(54) NEAR FIELD RADAR BEAMFORMING

(71) Applicant: GM CRUISE HOLDINGS LLC., San Francisco, CA (US)

(72) Inventor: Daniel Flores Tapia, Fairfield, CA (US)

(73) Assignee: GM CRUISE HOLDINGS LLC., San Francisco, CA (US)

(21) Appl. No.: 17/729,193

(22) Filed: Apr. 26, 2022

(51) Int. Cl. G01S 13/92; G01S 13/00; G01S 13/42; G01S 13/58; G01S 13/89

(52) U.S. Cl. CPC G01S 13/92; G01S 13/003; G01S 13/42; G01S 13/58; G01S 13/89

(57) ABSTRACT

Architectures and techniques for near field beamforming are disclosed. RADAR waveform data is received from a radio frequency front end. Range and movement information for one or more objects is generated from the received RADAR waveform data. A spatial frequency representation of the received RADAR waveform data is calculated. The spatial frequency representation of the received RADAR waveform data is migrated to a spatial space representation using a mapping function and interpolation. Signal processing operations are performed on the spatial space representation of the received RADAR waveform data. The spatial space representation of the received RADAR waveform data is converted to a Cartesian space representation. Information corresponding to the one or more objects in the Cartesian space representation is generated.

### TECHNICAL FIELD

Examples provided herein relate to beamforming for automotive radio detection and ranging (RADAR) sensor systems. More particularly, examples provided herein relate to a low latency approach to create information rich Point clouds using radar responses at very short distances (e.g., 30 cm or less).

### BACKGROUND

Autonomous vehicles, also known as self-driving cars, driverless vehicles, and robotic vehicles, may be vehicles that use multiple sensors to sense the environment and move without human input. Sensors involved in autonomous operation can include RADAR as well as other types of sensors. Automation technology based on the sensors in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an example autonomous vehicle.

FIG. 2 a block diagram of an example automotive radar system illustrating transmit and receive capability.

FIG. 3 is a block diagram of an example RADAR signal chain that can provide near field beamforming.

FIG. 4 is a flow diagram for one technique for operation of a RADAR signal chain that can provide near field beamforming.

FIG. 5 is a block diagram of one example of a processing system that can function with a RADAR signal chain that can provide near field beamforming.

FIG. 6 is a flow diagram for one technique for operation of a RADAR signal chain that can provide near field beamforming.

FIG. 7 is a block diagram of one example of a processing system that can function with a RADAR signal chain that can provide near field beamforming.

### DETAILED DESCRIPTION

Current radio detection and ranging (RADAR) point cloud formation strategies (also known as beamforming approaches) make use of wavefront far field approximation, which models the RADAR waveform as having a straight phase front. This approximation is used due to is ease of implementation and relatively small latency. While this approximation approach is generally satisfactory at longer distances, these far field based beamforming methods are inadequate when dealing with situations where the target object is in the spherical portion of the transmission/receiver antenna wavefront.

Processing chains that take advantage of the spherical wavefront variations to create point cloud responses from targets in the reflective near field are described below. In an example, the processing chains can use a parallel computing approach to merge, filter and generate an image in the time domain. Processing can be accomplished using texture based processing (in some examples this can performed by graphical processing units, or GPUs). Compared to previous approaches the approaches described herein can provide a significant performance increase, which can provide an improved user experience (e.g., reduced latency) in, for example, an autonomous vehicle environment.

The techniques described herein are based on advantageous conversion between a time domain and a frequency domain. The time domain and time domain analysis generally refers to the analysis of data with respect to time using mathematical functions/models. In contrast, the frequency domain generally refers to the analysis of data with respect to frequency rather than time. Thus, a time domain graph can show how a signal changes over time and a frequency domain graph for the same signal shows how much of the signal lies within one or more frequency bands. Frequency domain representation of data can simplify mathematical analysis used on RADAR near field beamforming.

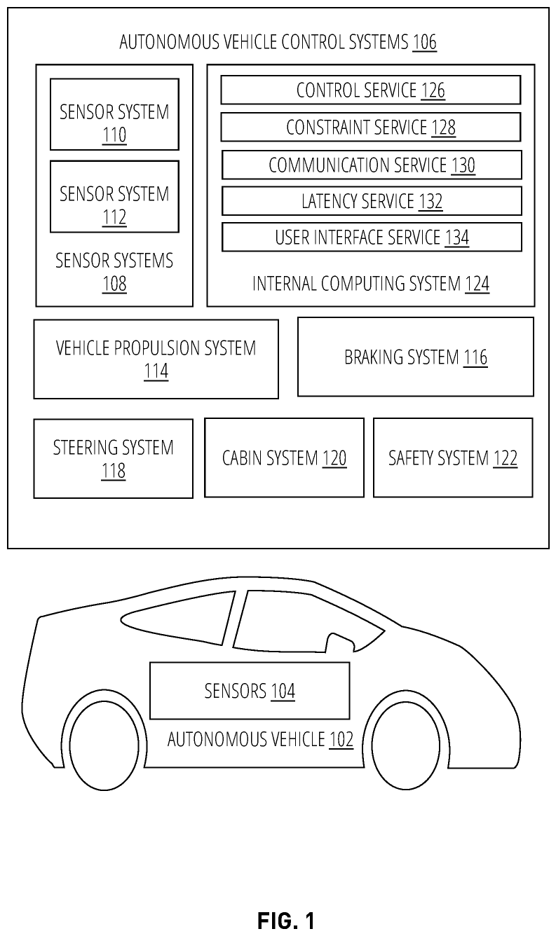

FIG. 1 is a block diagram of an example autonomous vehicle. Autonomous vehicle 102 has the functionality to navigate roads without a human driver by utilizing sensors 104 and autonomous vehicle control systems 106.

Autonomous vehicle 102 can include, for example, sensor systems 108 including any number of sensor systems (e.g., sensor system 110, sensor system 112). Sensor systems 108 can include various types of sensors that can be arranged throughout autonomous vehicle 102. For example, sensor system 110 can be a camera sensor system. As another example, sensor system 112 can be a light detection and ranging (LIDAR) sensor system. As a further example, one of sensor systems 108 can be a radio detection and ranging (RADAR) sensor system, an electromagnetic detection and ranging (EmDAR) sensor system, a sound navigation and ranging (SONAR) sensor system, a sound detection and ranging (SODAR) sensor system, a global navigation satellite system (GNSS) receiver system, a global positioning system (GPS) receiver system, accelerometers, gyroscopes, inertial measurement unit (IMU) systems, infrared sensor systems, laser rangefinder systems, microphones, etc.

As described in greater detail below, one of sensor systems 108 can be a RADAR sensor system having the described functionality for near field beamforming. This can result in a higher performance autonomous vehicle control systems 106 when interacting with target objects within a close proximity to autonomous vehicle 102. Point clouds generated as described herein can be, in an autonomous vehicle example, provided to a perception agent that can be utilized by and/or be part of autonomous vehicle control systems 106 to control operation of the host autonomous vehicle 102. Similarly, a human-operated vehicle having an advanced driver assistance system (ADAS) can utilize the perception agent to provide driver assistance and/or driver feedback.

Autonomous vehicle 102 can further include mechanical systems to control and manage motion of autonomous vehicle 102. For example, the mechanical systems can include vehicle propulsion system 114, braking system 116, steering system 118, cabin system 120 and safety system 122. Vehicle propulsion system 114 can include, for example, an electric motor, an internal combustion engine, or both. Braking system 116 can include an engine brake, brake pads, actuators and/or other components to control deceleration of autonomous vehicle 102. Steering system 118 can include components that control the direction of autonomous vehicle 102. Cabin system 120 can include, for example, cabin temperature control systems, in-cabin infotainment systems and other internal elements.

Safety system 122 can include various lights, signal indicators, airbags, systems that detect and react to other vehicles. Safety system 122 can include one or more radar systems. Autonomous vehicle 102 can utilize different types of radar systems, for example, long-range radar (LRR), mid-range radar (MRR) and/or short-range radar (SRR). LRR systems can be used, for example, to detect objects that are farther away (e.g., 200 meters, 300 meters) from the vehicle transmitting the signal. LRR systems can operate in the 77 GHz band (e.g., 76-81 GHz). SRR systems can be used, for example, for blind spot detection or collision avoidance. SRR systems can operate in the 24 GHz band. MRR systems can operate in either the 24 GHz band or the 77 GHz band. Other frequency bands can also be supported.

Autonomous vehicle 102 can further include internal computing system 124 that can interact with sensor systems 108 as well as the mechanical systems (e.g., vehicle propulsion system 114, braking system 116, steering system 118, cabin system 120 and safety system 122). Internal computing system 124 includes at least one processor and at least one memory system that can store executable instructions to be executed by the processor. Internal computing system 124 can include any number of computing sub-systems that can function to control autonomous vehicle 102. Internal computing system 124 can receive inputs from passengers and/or human drivers within autonomous vehicle 102.

Internal computing system 124 can include control service 126, which functions to control operation of autonomous vehicle 102 via, for example, the mechanical systems as well as interacting with sensor systems 108. Control service 126 can interact with other systems (e.g., constraint service 128, communication service 130, latency service 132 and internal computing system 124) to control operation of autonomous vehicle 102.

Internal computing system 124 can also include constraint service 128, which functions to control operation of autonomous vehicle 102 through application of rule-based restrictions or other constraints on operation of autonomous vehicle 102. Constraint service 128 can interact with other systems (e.g., control service 126, communication service 130, latency service 132, user interface service 134) to control operation of autonomous vehicle 102.

Internal computing system 124 can further include communication service 130, which functions to control transmission of signals from, and receipt of signals by, autonomous vehicle 102. Communication service 130 can interact with safety system 122 to provide the waveform sensing, amplification and repeating functionality described herein. Communication service 130 can interact with other systems (e.g., control service 126, constraint service 128, latency service 132 and user interface service 134) to control operation of autonomous vehicle 102.

Internal computing system 124 can also include latency service 132, which functions to provide and/or utilize timestamp information on communications to help manage and coordinate time-sensitive operations within internal computing system 124 and autonomous vehicle 102. Thus, latency service 132 can interact with other systems (e.g., control service 126, constraint service 128, communication service 130, user interface service 134) to control operation of autonomous vehicle 102.

Internal computing system 124 can further include user interface service 134, which functions to provide information to, and receive inputs from, human passengers within autonomous vehicle 102. This can include, for example, receiving a desired destination for one or more passengers and providing status and timing information with respect to arrival at the desired destination. User interface service 134 can interact with other systems (e.g., control service 126, constraint service 128, communication service 130, latency service 132) to control operation of autonomous vehicle 102.

Internal computing system 124 can function to send and receive signals from autonomous vehicle 102 regarding reporting data for training and evaluating machine learning algorithms, requesting assistance from a remote computing system or a human operator, software updates, rideshare information (e.g., pickup and/or dropoff requests and/or locations), etc.

In some examples described herein autonomous vehicle 102 (or another device) may be described as collecting data corresponding to surrounding vehicles. This data may be collected without associated identifiable information from these surrounding vehicles (e.g., without license plate numbers, make, model, and the color of the surrounding vehicles). Accordingly, the techniques mentioned here can because for the beneficial purposes described, but without the need to store potentially sensitive information of the surrounding vehicles.

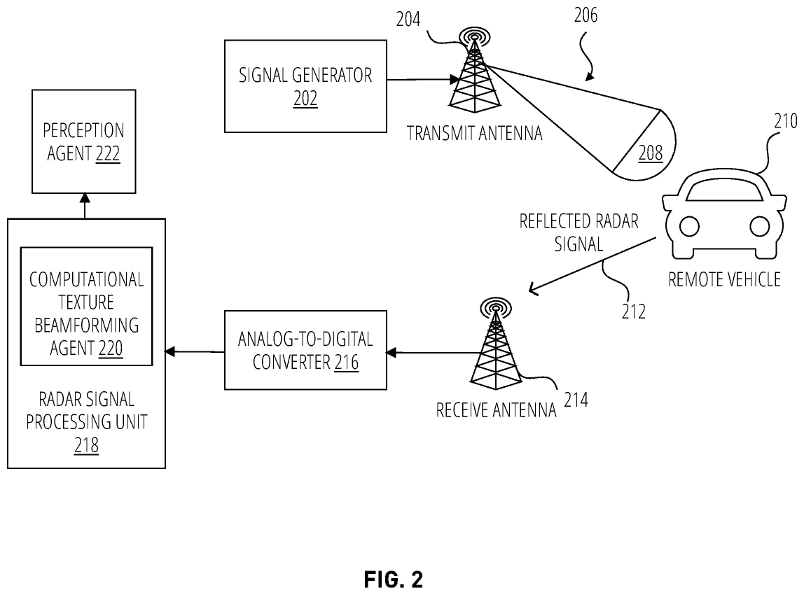

FIG. 2 a block diagram of an example automotive radar system illustrating transmit and receive capability. The radar system of FIG. 2 can be, for example, one of sensor systems 108 in autonomous vehicle 102. In other examples, the automotive radar system of FIG. 2 can be part of a human-operated vehicle having an ADAS that can utilize various sensors including radar sensors.

Signal generator 202 can be, for example, a frequency-modulated continuous wave (FMCW) generator that produces a series of chirps, which are sinusoid signals have frequencies that sweep from a pre-selected minimum frequency to a pre-selected maximum frequency to be transmitted from, for example, a host platform (e.g., autonomous vehicle 102, human operated ADAS vehicle, automated delivery vehicle). Other signal types (e.g., non-FMCW) can also be supported.

The signal generated by signal generator 202 provides a radar frequency signal to be transmitted by transmit antenna 204 (which can be a single antenna or an antenna array) as transmitted RADAR signal 206 having spherical portion 208. Transmitted RADAR signal 206 can be reflected by a remote object, for example, remote vehicle 210. Reflected radar signal 212 is detected by receive antenna 214, which can be a single antenna or an antenna array. The received reflected radar signal 212 from receive antenna 214 can be digitized by analog-to-digital converter 216 to generate digital RADAR waveforms that are transmitted to RADAR signal processing unit 218.

In an example, RADAR signal processing unit 218 includes computational texture beamforming agent 220, which can provide the near field beamforming functionality described in greater detail below. Computational texture beamforming agent 220 can provide real time (or near real time) near field RADAR beamforming functionality for RADAR signal processing unit 218. As described in greater detail below, this can be useful for sub-meter settings. RADAR signal processing unit 218 can provide information to perception agent 222, which can be utilized to control an autonomous vehicle or to provide driver feedback and/or assistance in an ADAS environment.

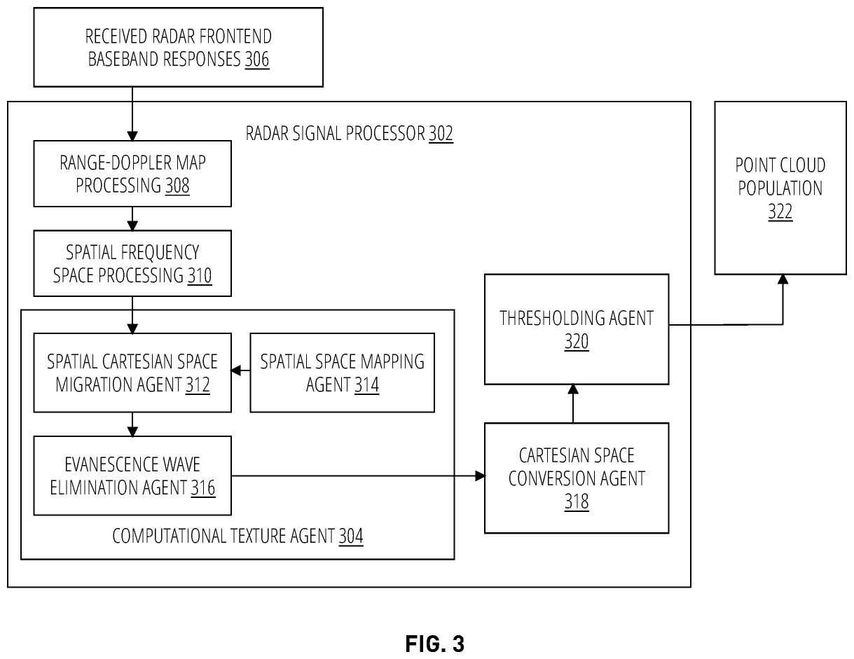

FIG. 3 is a block diagram of an example RADAR signal chain that can provide near field beamforming. RADAR signal processor 302 and computational texture agent 304 can be analogous to RADAR signal processing unit 218 and computational texture beamforming agent 220, respectively, of FIG. 2.

RADAR signal processor 302 can receive received RADAR frontend baseband responses 306 from, for example, one or more RADAR radio frequency (RF) receivers (not illustrated in FIG. 3). The architecture described herein can provide near field beamforming corresponding to received RADAR frontend baseband responses 306 with a low enough latency to operate in real time, or near real time.

RADAR signal processor 302 can perform range-Doppler map processing 308 and spatial frequency space processing 310. In general, range-Doppler map processing 308 can be useful to determine how far away targets are located and how quickly they are approaching or receding. Range-Doppler map processing 308 can also distinguish among targets moving at various speeds at various ranges. Spatial frequency space processing 310 refers to calculation of a spatial frequency representation of the data from range-Doppler map processing 308 calculated along the signal travel time direction (fast time) and the antenna array element direction (slow time).

Spatial space mapping agent 314 creates a mapping function, M(kw,kwx), based on the geometry of the antenna array to migrate the phase delays of a spherical spatial spectrum to a Cartesian (i.e., (kx,ky)) frequency space using the spatial frequency representation model. The mapping function (M(kw,kwx)) can be implemented as a graphic texture computational structure to be processed by computational texture agent 304.

Spatial Cartesian space migration agent 312 maps the spatial frequency representation of the data with the mapping function from spatial space mapping agent 314 using a linear interpolation approach. In an example, the interpolation is accomplished by defining a target Cartesian frequency space (kx, ky, kz) grid. An uneven grid corresponding to the signal frequency space (kw, kx, ky) is defined with respect to (kx, ky, kz) based on the mapping function between both representations. The uneven interpolation space is used as a basis to interpolate the values in the (kx, ky, kz) grid. Using the approach described, the mapping function process and its implementation, the interpolation step, which can be the most complex part of the beamforming process, can have a computational cost of O(1).

Evanescence wave elimination agent 316 eliminates null field waves. Moving data between domains (e.g., spatial, time) can create data gaps. These gaps can be filled by use of interpolation techniques, for example to provide a well-sampled grid. When converting back to the time domain, the responses that do not have a physical source should be eliminated before the conversion.

Cartesian space conversion agent 318 converts the output from computational texture agent 304 to the spatial Cartesian domain. In an example, a constant false alarm rate (CFAR) threshold can be applied to the data by thresholding agent 320. Application of the CFAR threshold can be utilized to keep false alarms below a pre-selected acceptable threshold rate. Point cloud population 322 can be accomplished with the filtered data from thresholding agent 320.

The approach described herein can also provide improved use of information. Because the reflections of all portions of the wavefront are integrated ruing the spatial domain conversion, all the collected information from a given target is processed. This is not the case with previous beamforming approaches, such as methods that perform a thresholding in the preprocessing stage.

The approach described herein can be used with non-uniform antenna arrays. Due to the nature of the mapping design process, the example approaches described are suitable for use with non-uniform antenna arrays. This is due to the way in which the mapping function is derived.

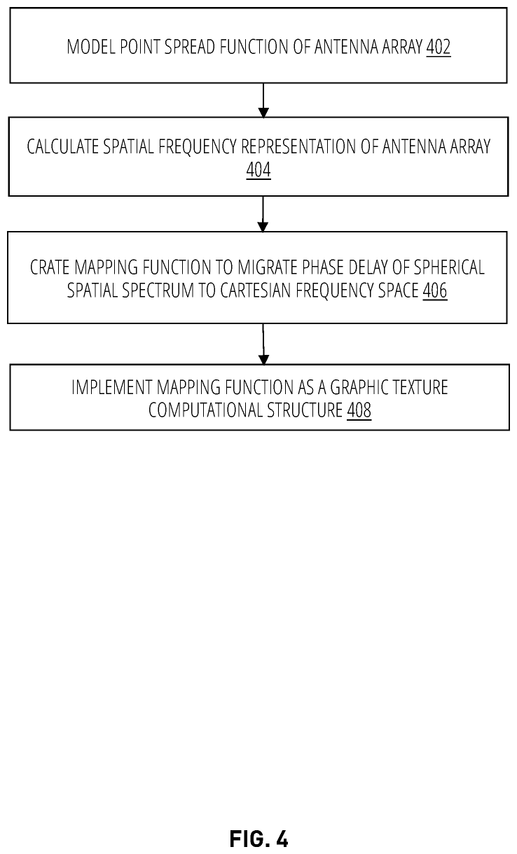

FIG. 4 is a flow diagram for one technique for operation of a RADAR signal chain that can provide near field beamforming. The functionality described with respect to FIG. 4 is generally a preliminary technique that can be performed as part of system configuration and/or in response to a system reconfiguration or adjustment.

A point spread function for the RADAR antenna array can be modeled, 402. This modeling can be accomplished by using a Fourier analysis, for example. The model can be used to calculate a spatial frequency representation of the antenna array, 404. In an example, this can be accomplished using an Erdelyi Approximation.

A mapping function, M(kw, kwx), is created based on the geometry of the antenna array to migrate the phase delays of a spherical spatial spectrum to a Cartesian (i.e., (kx, ky)) frequency space using the spatial frequency representation model, 406. The mapping function (M(kw, kwx)) can be implemented as a graphic texture computational structure, 408. In an example, the mapping function can be utilized by RADAR signal processor 302 to provide near field beamforming functionality.

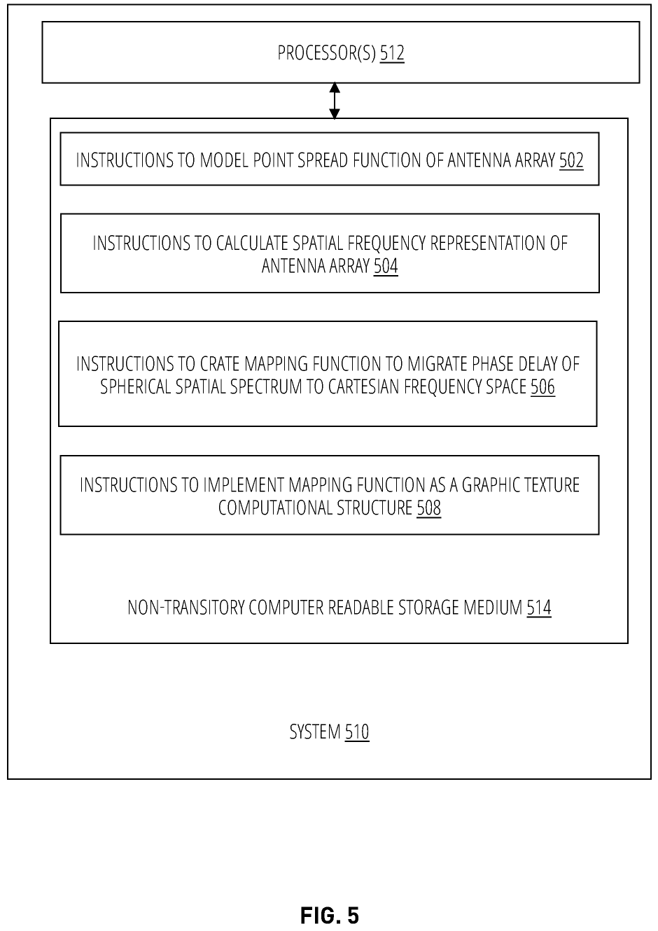

FIG. 5 is a block diagram of one example of a processing system that can function with a RADAR signal chain that can provide near field beamforming. In one example, system 510 can be part of an autonomous vehicle (e.g., autonomous vehicle 102 as part of internal computing system 124) that utilizes various sensors including radar sensors. In other examples, system 510 can be part of a human-operated vehicle having an ADAS that can utilize various sensors including radar sensors. In other examples, system 510 can be external to an automotive platform and can provide configuration and/or initiation functionality.

In an example, system 510 can include processor(s) 512 and non-transitory computer readable storage medium 514. Non-transitory computer readable storage medium 514 may store instructions 502, 504, 506 and 508, that, when executed by processor(s) 512, cause processor(s) 512 to perform various functions. Examples of processor(s) 512 may include a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of a non-transitory computer readable storage medium 514 include tangible media such as random access memory (RAM), read-only memory (ROM), electrically erasable programmable read-only memory (EEPROM), flash memory, a hard disk drive, etc.

Instructions 502 cause processor(s) 512 to model a point spread function for the RADAR antenna array. This modeling can be accomplished by using a Fourier analysis, for example. Instructions 504 cause processor(s) 512 to calculate a spatial frequency representation of the antenna array using the antenna array model. The spatial frequency representation can be calculated using an Erdelyi Approximation, for example.

Instructions 506 cause processor(s) 512 to create a mapping function, M(kw, kwx), based on the geometry of the antenna array to migrate the phase delays of a spherical spatial spectrum to a Cartesian (i.e., (kx, ky)) frequency space using the spatial frequency representation model. Instructions 508 cause processor(s) 512 to implement the mapping function (M(kw, kwx)) as a graphic texture computational structure. In an example, the mapping function can be utilized by RADAR signal processor 302 to provide near field beamforming functionality.

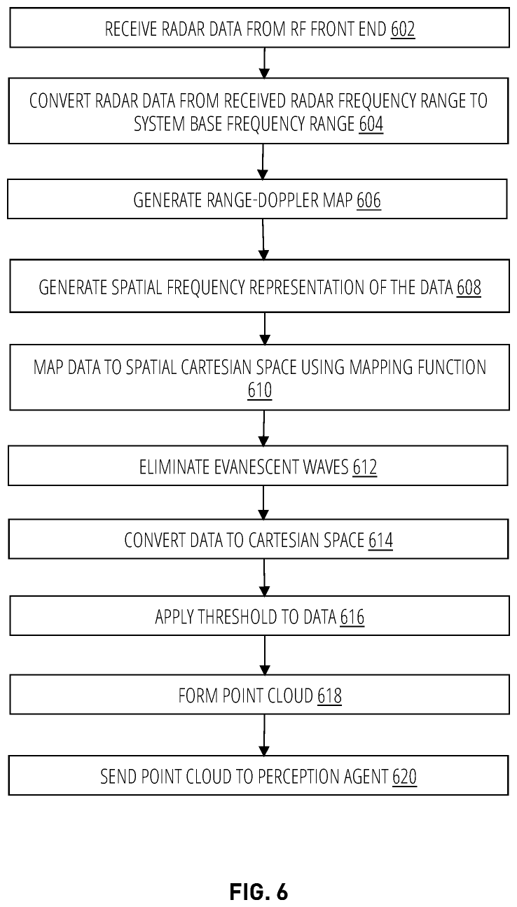

FIG. 6 is a flow diagram for one technique for operation of a RADAR signal chain that can provide near field beamforming. In one example, the technique of FIG. 6 can be provided by an autonomous vehicle (e.g., autonomous vehicle 102 as part of internal computing system 124) that utilizes various sensors including radar sensors. In other examples, the technique of FIG. 6 can be provided by a human-operated vehicle having an ADAS that can utilize various sensors including radar sensors.

RADAR data (e.g., received RADAR frontend baseband responses 306) is received from a radio frequency (RF) front end, 602. The RF front end can include various receiving components, for example, an antenna (or antenna array), an analog-to-digital converter and/or other relevant components. One example of these components is provided in FIG. 2 including at least receive antenna 214 and analog-to-digital converter 216. The received RADAR signal can be in an automotive RADAR frequency range, examples of which are provided above with respect to FIG. 1.

The received RADAR data is converted from the RADAR frequency range to a system base frequency range, 604. The system base frequency range is lower than the RADAR frequency range. The received high-frequency RF signal can be converted from the first frequency range to a corresponding lower-frequency signal in a second frequency range by using a heterodyne mixer, for example. Various frequency ranges can be supported for the lower-frequency system base frequency range signal.

A range-Doppler map is generated from the lower-frequency data, 606. Range-Doppler maps can be utilized to extract the distance of a target object and a radial velocity of the target object. Various techniques can be used to generate the range-Doppler maps. In general, the range-Doppler map can be useful to determine how far away targets are located and how quickly they are approaching or receding with respect to the host autonomous vehicle. The range-Doppler map can also be useful to distinguish among targets moving at various speeds at various ranges.

A spatial frequency representation of the data can be calculated, 608. In an example, the spatial frequency representation of the data is calculated along the signal travel time direction (fast time) and the antenna array element direction (slow time). In general, the spatial frequency is a measure of how often sinusoidal components (for example, as determined by a Fourier transform) of the signal structure repeat per unit of distance. In the antenna array examples herein, computations become complex because there are multiple overlapping fields. In an example, responses of the sensors are determined based on where sensors are pointed.

The data (in the spatial frequency representation) is mapped using the previously determined mapping function (e.g., M(kw, kwx) as described with respect to FIG. 3, FIG. 4 and FIG. 5) to (kx, ky) space using, for example, linear interpolation, 610. The approach described herein has a computational complexity of O(1) when supported by the approach described with respect to FIG. 4 and FIG. 5. In an example, converted and mapped data can be processed as textural elements using, for example, computational texture processing components (e.g., GPUs) that are designed and optimized for specific textural processing operations. This allows the RADAR signal processing for near field reflected waveforms to be processed in real time (or near real time). Previous approaches resulted in excessive latency and/or are not able to sufficiently process the spherical portion of the RADAR waveform.

Operations to provide the functionality described performed in time domain is based on convolutions; however, in frequency domain the corresponding functionality can be based on divisions, which is less computationally complex. Thus, the described conversion from the time domain to the frequency domain results in a less computationally complex division-based approach as compared to a convolution-based approach in the time domain.

Evanescent (null field) waves are eliminated, 612. Moving data between domains (e.g., spatial, time) can create data gaps. These gaps can be filled by use of interpolation techniques, for example to provide a well-sampled grid. When converting back to the time domain, the responses that do not have a physical source should be eliminated before the conversion.

The data is converted to Cartesian space, 614. The data can be filtered and/or thresholds applied, 616. In an example, a constant false alarm rate (CFAR) threshold can be applied to the data. Application of the CFAR threshold can be utilized to keep false alarms below a pre-selected acceptable threshold rate. A point cloud can be formed from the filtered data, 618. The point cloud can be sent to a perception agent or other control system component, 620.

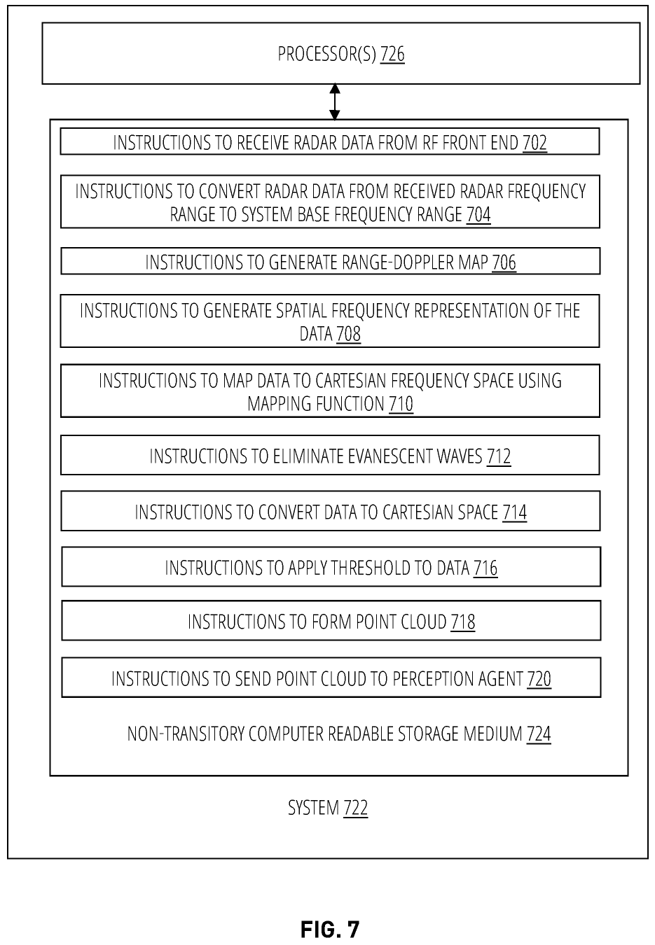

FIG. 7 is a block diagram of one example of a processing system that can function with a RADAR signal chain that can provide near field beamforming. In one example, system 722 can be part of an autonomous vehicle (e.g., autonomous vehicle 102 as part of internal computing system 124) that utilizes various sensors including radar sensors. In other examples, system 722 can be part of a human-operated vehicle having an ADAS that can utilize various sensors including radar sensors.

In an example, system 722 can include processor(s) 726 and non-transitory computer readable storage medium 724. Non-transitory computer readable storage medium 724 may store instructions 702, 704, 706, 708, 710, 712, 714, 716, 718 and 720, that, when executed by processor(s) 726, cause processor(s) 726 to perform various functions. Examples of processor(s) 726 may include a microcontroller, a microprocessor, a CPU, a GPU, a DPU, an ASIC, an FPGA, an SoC, etc. Examples of a non-transitory computer readable storage medium 724 include tangible media such as RAM, ROM, EEPROM, flash memory, a hard disk drive, etc.

Instructions 702 cause processor(s) 726 to receive RADAR data from RF front end. The RF front end can include various receiving components, for example, an antenna (or antenna array), an analog-to-digital converter and/or other relevant components. One example of these components is provided in FIG. 2 including at least receive antenna 214 and analog-to-digital converter 216. The received RADAR signal can be in an automotive RADAR frequency range, examples of which are provided above with respect to FIG. 1.

Instructions 704 cause processor(s) 726 to convert RADAR data from received RADAR frequency range to system base frequency range. The system base frequency range is lower than the RADAR frequency range. The received high-frequency RF signal can be converted from the first frequency range to a corresponding lower-frequency signal in a second frequency range by using a heterodyne mixer, for example. Various frequency ranges can be supported for the lower-frequency system base frequency range signal.

Instructions 706 cause processor(s) 726 to generate range-Doppler map. Range-Doppler maps can be utilized to extract the distance of a target object and a radial velocity of the target object. Various techniques can be used to generate the range-Doppler maps. In general, the range-Doppler map can be useful to determine how far away targets are located and how quickly they are approaching or receding with respect to the host autonomous vehicle. The range-Doppler map can also be useful to distinguish among targets moving at various speeds at various ranges.

Instructions 708 cause processor(s) 726 to generate spatial frequency representation of the data. In an example, the spatial frequency representation of the data is calculated along the signal travel time direction (fast time) and the antenna array element direction (slow time). In general, the spatial frequency is a measure of how often sinusoidal components (for example, as determined by a Fourier transform) of the signal structure repeat per unit of distance. In the antenna array examples herein, computations become complex because there are multiple overlapping fields. In an example, responses of the sensors are determined based on where sensors are pointed.

Instructions 710 cause processor(s) 726 to map data to spatial Cartesian space using mapping function. The approach described herein has a computational complexity of O(1) when supported by the approach described with respect to FIG. 4 and FIG. 5. In an example, converted and mapped data can be processed as textural elements using, for example, computational texture processing components (e.g., GPUs) that are designed and optimized for specific textural processing operations. This allows the RADAR signal processing for near field reflected waveforms to be processed in real time (or near real time). Previous approaches resulted in excessive latency and/or are not able to sufficiently process the spherical portion of the RADAR waveform.

Instructions 712 cause processor(s) 726 to eliminate evanescent waves. Moving data between domains (e.g., spatial, time) can create data gaps. These gaps can be filled by use of interpolation techniques, for example to provide a well-sampled grid. When converting back to the time domain, the responses that do not have a physical source should be eliminated before the conversion. Instructions 714 cause processor(s) 726 to convert data to Cartesian space.

Instructions 716 cause processor(s) 726 to filter the data and/or apply one or more thresholds. In an example, a CFAR threshold can be applied to the data. Application of the CFAR threshold can be utilized to keep false alarms below a pre-selected acceptable threshold rate. Instructions 718 cause processor(s) 726 to for a point cloud from the filtered data. Instructions 720 cause processor(s) 726 to send the point cloud to a perception agent or other control system component.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, ROM, RAM, EPROM, EEPROM, magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 514 and/or non-transitory computer readable storage medium 724 have stored thereon data representing sequences of instructions that, when executed by processor(s) 512 or processor(s) 726, cause processor(s) 512 and/or processor(s) 726 to perform certain operations.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. An autonomous vehicle comprising:
sensor systems to detect characteristics of an operating environment comprising at least a radio detection and ranging (RADAR) sensor system, the sensor systems to:
receive RADAR waveform data from a radio frequency front end of the RADAR sensor system;
generate range and movement information for one or more objects from the received RADAR waveform data;
calculate a spatial frequency representation of the received RADAR waveform data;
migrate the spatial frequency representation of the received RADAR waveform data to a spatial space representation using a mapping function and interpolation;
perform signal processing operations on the spatial space representation of the received RADAR waveform data;
convert the spatial space representation of the received RADAR waveform data to a Cartesian space representation; and
generate information corresponding to the one or more objects in the Cartesian space representation.

2. The autonomous vehicle of claim 1 wherein the sensor systems are further configured to populate a point cloud.

3. The autonomous vehicle of claim 1 wherein the sensor systems are further configured to:
model point spread function of an antenna array using Fourier analysis;
calculate a spatial frequency representation of the antenna array; and
map phase delays for a RADAR signal from a spherical spatial domain to a Cartesian domain, wherein the mapping is implemented in a graphic texture computational structure.

4. The autonomous vehicle of claim 3 wherein the spatial frequency representation of the antenna array is calculated using an Erdelyi approximation.

5. The autonomous vehicle of claim 3 wherein the translation of the phase delays for the RADAR signal from the spherical spatial domain to the Cartesian domain comprise generating a mapping function from the spherical spatial domain to the Cartesian domain based on a geometry of the antenna array using a spatial frequency representation model.

6. The autonomous vehicle of claim 1 wherein the spatial frequency representation of the converted RADAR data is calculated along a travel time direction (fast time) and an antenna array element direction (slow time).

7. A non-transitory computer-readable medium having stored thereon instructions that, when executed by one or more processors, are configurable to cause the processors to:
receive RADAR waveform data from a radio frequency front end;
generate range and movement information for one or more objects from the received RADAR waveform data;
calculate a spatial frequency representation of the received RADAR waveform data;
migrate the spatial frequency representation of the received RADAR waveform data to a spatial space representation using a mapping function and interpolation;
perform signal processing operations on the spatial space representation of the received RADAR waveform data;
convert the spatial space representation of the received RADAR waveform data to a Cartesian space representation; and
generate information corresponding to the one or more objects in the Cartesian space representation.

8. The non-transitory computer-readable medium of claim 7 further comprising instructions that, when executed by the one or more processors, cause the one or more processors to populate a point cloud.

9. The non-transitory computer-readable medium of claim 8 wherein the population of the point cloud is accomplished by a perception agent.

10. The non-transitory computer-readable medium of claim 7 further comprising instructions that, when executed by the one or more processors, cause the one or more processors to:
model point spread function of an antenna array using Fourier analysis;
calculate a spatial frequency representation of the antenna array; and
map phase delays for a RADAR signal from a spherical spatial domain to a Cartesian domain, wherein the mapping is implemented in a graphic texture computational structure.

11. The non-transitory computer-readable medium of claim 10 wherein the spatial frequency representation of the antenna array is calculated using an Erdelyi approximation.

12. The non-transitory computer-readable medium of claim 10 wherein the translation of the phase delays for the RADAR signal from the spherical spatial domain to the Cartesian domain comprise generating a mapping function from the spherical spatial domain to the Cartesian domain based on a geometry of the antenna array using a spatial frequency representation model.

13. The non-transitory computer-readable medium of claim 7 wherein the spatial frequency representation of the converted RADAR data is calculated along a travel time direction (fast time) and an antenna array element direction (slow time).

14. A system comprising:
a memory system; and
one or more hardware processors coupled with the memory system, the one or more processors to:
receive RADAR waveform data from a radio frequency front end;
generate range and movement information for one or more objects from the received RADAR waveform data;
calculate a spatial frequency representation of the received RADAR waveform data;
migrate the spatial frequency representation of the received RADAR waveform data to a spatial space representation using a mapping function and interpolation;
perform signal processing operations on the spatial space representation of the received RADAR waveform data;
convert the spatial space representation of the received RADAR waveform data to a Cartesian space representation; and
generate information corresponding to the one or more objects in the Cartesian space representation.

15. The system of claim 14 wherein the one or more hardware processors are further configured to populate a point cloud.

16. The system of claim 15 wherein the population of the point cloud is accomplished by a perception agent.

17. The system of claim 14 wherein the one or more hardware processors are further configured to:
model point spread function of an antenna array using Fourier analysis;
calculate a spatial frequency representation of the antenna array; and
map phase delays for a RADAR signal from a spherical spatial domain to a Cartesian domain, wherein the mapping is implemented in a graphic texture computational structure.

18. The system of claim 17 wherein the spatial frequency representation of the antenna array is calculated using an Erdelyi approximation.

19. The system of claim 17 wherein the translation of the phase delays for the RADAR signal from the spherical spatial domain to the Cartesian domain comprise generating a mapping function from the spherical spatial domain to the Cartesian domain based on a geometry of the antenna array using a spatial frequency representation model.

20. The system of claim 14 wherein the spatial frequency representation of the converted RADAR data is calculated along a travel time direction (fast time) and an antenna array element direction (slow time).
